(19) United States
(12) Patent Application Publication
(10) Pub. No.: US 2014/0174488 A1
(43) Pub. Date: Jun. 26, 2014

(54) CLEANING DEVICE WITH MULTILAYER SUPPORT

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/867,113

(22) Filed: Apr. 21, 2013

(30) Foreign Application Priority Data
Dec. 21, 2012 (TW) 101149092

(51) Int. Cl. B08B 3/10; B08B 3/12

(52) U.S. Cl. CPC B08B 3/102; B08B 3/12
USPC 134/184

(57) ABSTRACT

A cleaning device includes a cleaning tank, a vibrator, and a number of loading plates. The cleaning tank contains cleaning liquid. The vibrator is received in the cleaning tank. The loading plates are received in the cleaning tank, and are stacked one by one in the cleaning tank. Each of the loading plates supports a workpiece in the cleaning tank.

### BACKGROUND

1. Technical Field

The present disclosure relates to a cleaning device.

2. Description of Related Art

Currently, workpieces (such as steel plates) are cleaned one by one using brushes, and thus the working efficiency is low.

Therefore, it is desirable to provide a cleaning device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a cleaning device, according to an exemplary embodiment.

FIG. 2 is a schematic, exploded view of the cleaning device of FIG. 1.

FIG. 3 is a cut-away view of the cleaning device.

### DETAILED DESCRIPTION

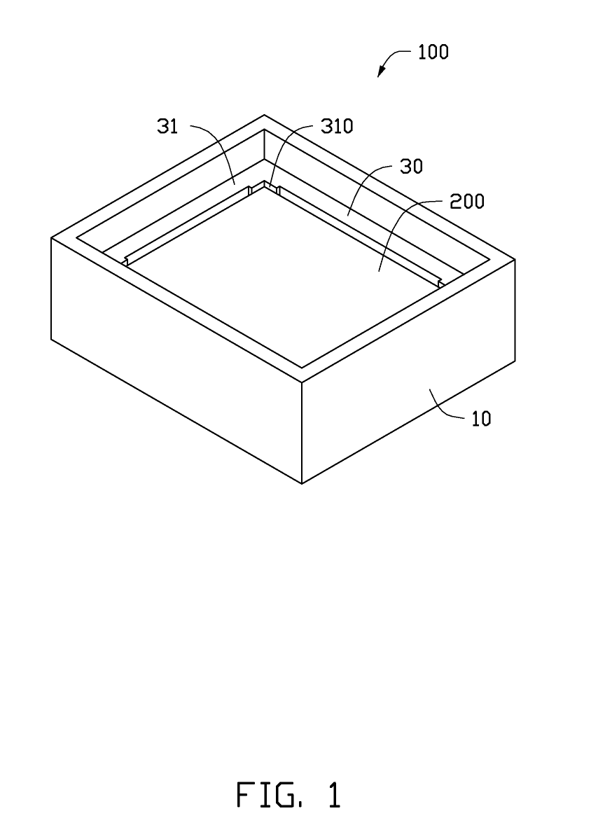

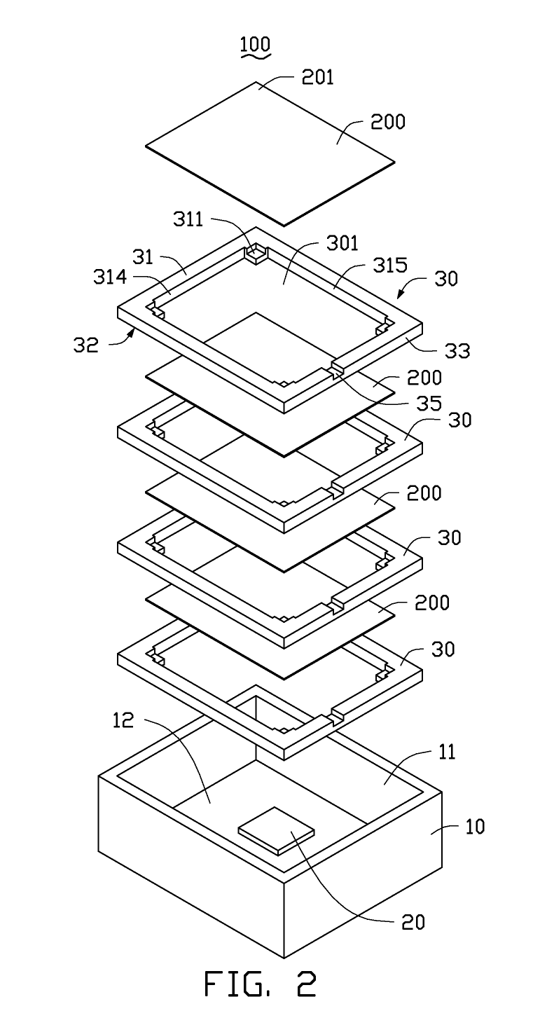

FIG. 1 and FIG. 2 illustrate a cleaning device 100 in accordance with an embodiment. The cleaning device 100 is used for cleaning a number of workpieces 200 (such as steel plates). The workpiece 200 is substantially cubic, and includes four rectangular portions 201.

The cleaning device 100 includes a cleaning tank 10, a vibrator 20, and a number of loading plates 30. The vibrator 20 and the loading plates 30 are received in the cleaning tank 10. The loading plates 30 are stacked one by one.

The cleaning tank 10 is used for receiving cleaning liquid, and has an opening 11 and a bottom wall 12 opposite to the opening 11.

The vibrator 20 is positioned on the bottom wall 12. In the embodiment, the vibrator 20 is an ultrasonic vibrator.

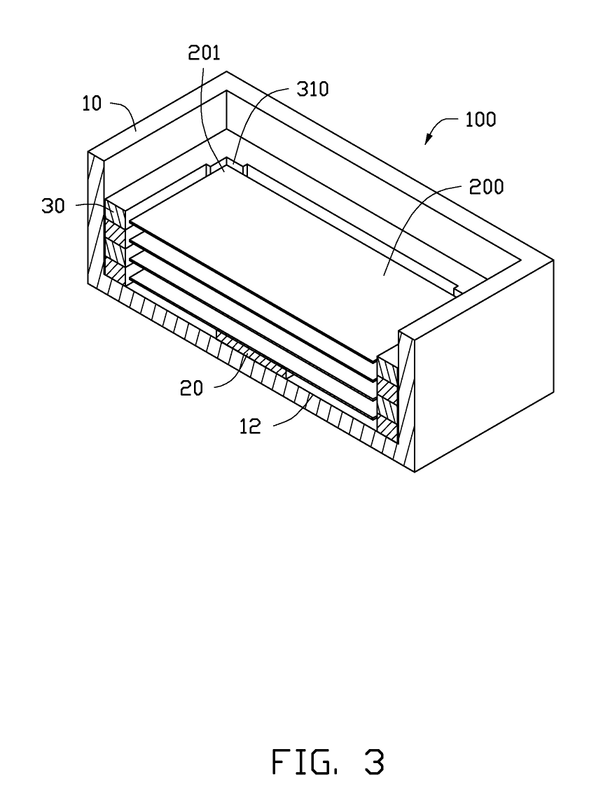

Also referring to FIG. 3, the configuration of the loading plates 30 are substantially the same as each other, and are stacked on the vibrator 20 one by one. Each of the loading plates 30 is used for loading a workpiece 200. Each of the loading plates 30 is substantially square-shaped, and includes a top surface 31, a bottom surface 32, and four side surfaces 33. The bottom surface 32 is opposite to the top surface 31. The four side surfaces 33 are connected to the top surface 31 and the bottom surface 32.

Each of the loading plates 30 defines a through hole 301 at the central portion thereof, and thus the workpieces 200 on the loading plates 30 can contact with the cleaning liquid. The through hole 301 is substantially square-shaped, and has four corners 310. Each of the loading plates 30 has four supporting portions 311 at the four corners 310, respectively. The four supporting portions 311 are used for supporting the workpieces 200 in the cleaning tank 10. In the embodiment, the supporting portion 311 is step-shaped.

The through hole 313 has two opposite first inner side walls 314 and two opposite second inner side walls 315. The two first inner side walls 314 are parallel to each other. The two second inner side walls 315 are parallel to each other. The workpiece 200 is separated from the two first inner sidewalls 314 and the two second inner sidewalls 315, and thus to form a number of gaps.

At least one of the outer side surfaces 33 defines a slot 35 communicating with the through hole 301, and thus the cleaning liquid can flow into two adjacent loading plates 30. In the embodiment, the slot 35 further passes through the top surface 31. The number of the slots 35 is not limited to the embodiment.

In use, each loading plate 30 supports a workpiece 200, then the loading plates 30 are stacked on by one on the vibrator 20, the cleaning liquid is poured into the cleaning tank 10, and thus the loading plates 30 are immersed in the cleaning liquid. The cleaning liquid enters the space between each two adjacent loading plates 30 through the gaps between the two second inner side walls 315 and the slots 35. The vibrator 20 is turned on, and the surfaces of the workpieces 200 are impacted with the cleaning liquid, and thus the surfaces of the workpieces 200 are washed.

In other embodiments, the cleaning tank 10 also can be other shapes (such as triangle), the number of the supporting portions 311 is not limited to the embodiment. The supporting portions 311 also can be positioned on other place in the cleaning tank 10.

By employing the cleaning device 100, a number of workpieces 200 can be washed at one time, and thus the working efficiency can be improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A cleaning device for cleaning a plurality of workpieces, comprising:
a cleaning tank for receiving cleaning liquid,
a vibrator received in the cleaning tank, and
a plurality of loading plates received in the cleaning tank, and stacked one by one, each of the loading plates configured for supporting a corresponding one of the workpieces in the cleaning tank.

2. The cleaning device of claim 1, wherein the cleaning tank comprises an opening and a bottom wall opposite to the opening, and the vibrator is positioned on the bottom wall.

3. The cleaning device of claim 1, wherein each of the loading plates comprises a top surface and a bottom surface opposite to the top surface, each of the loading plates defines a through hole passing through the top surface and the bottom surface, each of the loading plates comprises a plurality of supporting portions for supporting the corresponding workpiece in the cleaning tank, and thus the corresponding workpiece contacts with the cleaning liquid.

4. The cleaning device of claim 3, wherein each of the loading plates comprises at least one side surface connected to the top surface and the bottom surface, the at least one side surface defines at least one slot communicated with the through hole, and thus the cleaning liquid enters a space between each two adjacent loading plates through the at least one slot.

5. The cleaning device of claim 4, wherein the at least one slot passes through the top surface.

6. The cleaning device of claim 3, wherein the through hole comprises at least one inner side wall, and each of the loading plates separates from the corresponding workpiece when each of the loading plates loads the corresponding workpiece.

7. The cleaning device of claim 3, wherein the cleaning tank is substantially cubic, and the through hole comprises four corners, the number of the supporting portions is four, the four supporting portions are positioned at the four corners respectively.

8. The cleaning device of claim 7, wherein the four supporting portions are step-shaped.

9. The cleaning device of claim 1, wherein the vibrator is an ultrasonic vibrator.
